(19) United States
(12) Patent Application Publication
(10) Pub. No.: US 2026/0316283 A1
(43) Pub. Date: Oct. 15, 2026

(54) ROBOT CALIBRATION SYSTEM AND METHOD FOR CALIBRATING THE POSITION OF A ROBOT RELATIVE TO A WORKPLACE

(71) Applicant: IMPAQT ROBOTICS PRIVATE LIMITED, Chennai (IN)

(72) Inventor: Henning Forbech CHRISTENSEN, Aarhus C (DK)

(73) Assignee: IMPAQT ROBOTICS PRIVATE LIMITED, Chennai (IN)

(21) Appl. No.: 18/998,852

(22) PCT Filed: Jun. 20, 2023
(86) PCT No.: PCT/DK2023/050153

§ 371 Date: Jan. 27, 2025

(30) Foreign Application Priority Data
Jun. 28, 2022 (DK) PA202200723

(51) Int. Cl. B25J 9/16; B25J 19/02; G06T 7/50

(52) U.S. Cl. CPC B25J 9/1692; B25J 19/023; G06T 7/50; G06T 2207/30204

(57) ABSTRACT

A method for calibrating the position and orientation of a robot with respect to a predefined plane and point of reference of a workplace comprising the step of providing the robot with a camera having a camera center, positioning the camera in a first position, in which the camera faces a mirror tag comprising a reflective zone, wherein the reflective zone of the mirror tag has a planar surface extending along a first plane, and moving the camera until the first plane of the mirror tag is perpendicular to the center axis of the camera.

### CROSS REFERENCE TO RELATED APPLICATIONS

This is a National Phase application of PCT/DK2023/050153, filed Jun. 20, 2023, which relies for priority on Danish Application Serial No. PA202200723 filed on Jul. 28, 2022, now pending, the entire specification of which is incorporated by reference as if fully set forth herein.

### FIELD OF INVENTION

The present invention generally relates to a robot calibration system and a method for calibrating the position of a robot relative to a workplace.

### BACKGROUND ART

Due to rapid technological advancements within the field of robotics and automation, the manufacturing industry has witnessed an increased adoption of robotics engineering and technology into its production processes.

Today, industrial robots are used to perform tasks with high precision and repeatability resulting in products of high quality. The ability of industrial robots to work continuously without requiring breaks enables manufacturers to increase the output. Besides, robots are suitable for working in dangerous and harmful environments. Accordingly, the several advantages of industrial robots have encouraged many manufacturers to integrate different types of industrial robots in their production line to increase plant efficiency and profitability.

Robotic industrial automation has successfully been introduced in large-scale manufacturing because it offers significant advantages at scale for tasks such as welding, cutting, stamping, painting, heavy material handling and precision material machining.

Articulated robots are often used in setups, in which the robot arm is not automatically placed in a well-defined position relative to the workplace. The robot may typically be moved with respect to a mobile platform, or the workplace may be placed on a conveyer system. Many robot arms are suitable for very precise finishing, assembly, and electronics tasks. By way of example Universal Robots' e-Series collaborative articulated robots feature repeatability of 0.03 mm in the UR3e and UR5e models and 0.05 mm in the UR10e and UR16e. If the workpiece or fixture is located at a workplace that is, however, not aligned with the robot arm the benefit from this high precision is lost.

To solve this problem, mobile robots are often locked to a workplace with a zero-point system to coordinate the two reference systems. The robot can also be aligned by a haptic aligner, wherein the robot arm is brought into contact with a reference plate placed on or attached to the workplace. Manual alignment with a haptic system is, however, time consuming and requires highly skilled staff and cannot be done automatically by the robot.

Optical systems featuring cameras are often preferred because these systems allow the alignment to be accomplished without any physical contact or operator involvement. The most frequently used optical systems apply a camera that is arranged and configured to analyse an image of a tag placed on the counterpart. Often these tags or fiducial markers has a chess board pattern or looks like a simple QR-code.

These optical systems are typical capable of determining the position to within a few mm but the accuracy of the angle adjustment is often poor, typically no better than +/−1°. With a 1° misalignment, the position will get an offset of 3.5 mm at a 200 mm distance from the alignment point. Due to the angular misalignment, this error is typically much larger than the position precision at the alignment point.

With a low-quality angular alignment, the robot arm will only have an acceptable position precision close to the alignment point. To give a mobile robot a large workspace on a workplace the angular precision of the alignment is more important than the position alignment.

Chinese Patent application CN111823222A discloses a monocular camera multi-field-of-view visual guidance device and a guidance method. The guidance device includes a camera, a plane mirror and a six-axis robot arranged in sequence, wherein the plane mirror is installed directly in front of the camera, and the plane mirror is driven by a drive mechanism. The virtual camera in the plane mirror is arranged on a circle with the motor shaft as the center having the distance from the motor shaft to the camera as the radius. The camera and the plane mirror are arranged according to the position of the positioned product. In practice, however, this solution does not solve the above-mentioned disadvantages of the prior art.

Thus, there is a need for a robot calibration system and a method for calibrating the position of a robot relative to a workplace which reduces or even eliminates the above-mentioned disadvantages of the prior art.

Accordingly, it is an object of the present invention to provide a robot calibration system and a method for calibrating the position of a robot relative to a workplace which provides a higher accuracy than the prior art systems.

### SUMMARY OF THE INVENTION

The object of the present invention can be achieved by a method as defined in claim 1 and by a mirror tag as defined in claim 8, and further by a robot calibration system as defined in claim 11. Preferred embodiments are defined in the dependent subclaims, explained in the following description, and illustrated in the accompanying drawings

The method according to the invention is a method for calibrating the position of a robot with respect to a predefined plane and point of reference of a workplace, wherein the method comprises the step of providing the robot with a camera having a camera center, wherein the method comprises the following steps:
positioning the camera in a first position, in which the camera faces a mirror tag comprising a reflective zone, which reflective zone is configured to reflect light emitted by the camera, wherein the reflective zone of the mirror tag has a planar surface extending along a first plane;
moving the camera until the first plane of the mirror tag is perpendicular to the center axis of the camera, wherein method comprises the step of bringing the camera into a position, in which the camera will be able to see itself in the reflective zone on the mirror tag.

Hereby, it is possible to provide a method for calibrating the position of a robot relative to a workplace which provides a higher accuracy than the prior art systems. Moreover, the method requires simple tools for being carried out.

The predefined plane may be a planar plane. The point of reference of the workplace, may be any desired point. In one embodiment, the point is arranged at the surface of the workplace. In one embodiment, the point is arranged on the surface of the reflective zone.

In one embodiment, the method comprises the step of providing the robot with a camera having a camera center, wherein the camera is configured to emit light along a center axis.

By the term “the camera is configured to emit light” is meant that the camera unit further comprises a light source that can illuminate the camera tag. When viewed along the center axis the camera tag will be seen as a ring around the lens.

In one embodiment, the robot is an articulated robot arm.

In one embodiment, the camera comprises an image sensor. In one embodiment, the image sensor of the camera is planar. The image sensor points towards a direction perpendicular to the lens center axis.

In one embodiment, the method comprises the step of positioning the camera in a first position, in which the camera faces a mirror tag comprising a reflective zone, which reflective zone is configured to reflect light emitted by the camera, wherein the reflective zone of the mirror tag has a planar surface extending along a first plane. Hereby, it is possible to use the reflective zone to reflect the light emitted by the camera.

The method comprises the step of moving the camera until the first plane of the mirror tag is perpendicular to the center axis of the camera. By doing this, the image sensor of the camera and the mirror tag extend parallel to each other.

The term “moving the camera” includes rotating the camera and/or displacing the camera. The camera is moved by means of the robot. In one embodiment, the robot is an articulated robot arm.

It is an advantage that the method comprises the step of bringing the camera into a position, in which the camera is able to see itself in the mirror tag. Hereby, the alignment of the mirror tag and the image sensor of the camera is eased.

It is important to note that if the robot has a rough idea on the position of the workplace, it will not be necessary for the operator to bring the camera into a position, in which the camera is able to see itself in the mirror tag will not be necessary.

By the term “the camera is able to see itself” is meant that the light emitted by the camera is reflected and received by the image sensor of the camera.

In one embodiment, the camera comprises a camera tag surrounding the camera lens.

In one embodiment, the camera comprises a circular camera tag surrounding the camera lens.

In one embodiment, the camera comprises a spherical camera tag surrounding the camera lens.

In one embodiment, the camera tag is located at the lens center.

Accordingly, when “the camera is able to see itself”, the camera also sees the camera tag. The camera tag will be seen by the camera as a ring around the lens.

If the center line of the lens is perpendicular to the reflective zone the ring formed by the camera tag in the image will be at the center of the image. If the ring formed by the camera tag is not at the center of the image the camera must be rotated along the X and/or the Y axis to bring the ring to the image center. By doing this the camera will be brought into an orientation where the camera center line is perpendicular to the reflective zone.

In other words, the first two of the six degrees of freedom are determined by this step of the method (see FIG. 1D, in which the rotation about the X axis and Y axis is determined).

With the camera center line perpendicular to the reflective zone the center of the image representant the point where the camera center line crosses the mirror tag.

The center of the image can now be used to position the camera in a position, in which the center axis of the camera points towards the center of the reflective zone of the mirror tag. It may be advantageous that the reflective zone of the mirror tag is circular.

In one embodiment the reflective zone of the mirror tag and the camera tag surrounding the camera lens are circular.

In one embodiment, the mirror tag comprises a plurality of predefined object each having a predefined size, color, geometry and position on the mirror tag, wherein the method comprises the following steps:
maintaining the orientation of the camera relative to the first plane;
displacing the camera along the first plane until the center axis of the camera is pointed towards one of the predefined point of one of the predefined object of the mirror tag.

Hereby, it is possible to displace the camera a predefined distance in a predefined direction, corresponding to the position of the predefined point the predefined object of the mirror tag. When the position of the predefined point of the predefined object of the mirror tag is known and the center axis of the camera is pointed towards the predefined point of the predefined object of the mirror tag, it is verified that the camera has been displaced the predefined distance in the predefined direction. In other words, two more of the six degrees of freedom are determined by this step of the method. In one embodiment, the procedure is repeated by using a predefined point of another predefined object of the mirror tag.

It may be an advantage that the predefined objects are positioned between the reflective zone and the edge of the mirror tag.

In one embodiment, the mirror tag comprises a layer of a transparent material. In one embodiment, the mirror tag comprises a layer of a glass. In one embodiment, the mirror tag comprises a layer of a plastic.

In one embodiment, the method comprises the step of determining the distance between the camera center and the mirror tag. This determination can, however, be carried out in different manners. It should be noted that determining the distance between the camera center and the mirror tag is equivalent to determining the distance between another area or point of the camera and the mirror tag. Accordingly, as an alternative, the method may comprise the step of determining the distance between a point or area of the camera center and the mirror tag.

In one embodiment, the step of determining the distance between the camera center and the mirror tag is accomplished by determining the distance between the camera center and the reflective zone of the mirror tag.

In one embodiment, the distance between the camera center and the mirror tag is determined by:
detecting the size of one of the predefined objects of the mirror tag, wherein the size of the predefined objects is known;
comparing the detected size of the predefined object of the mirror tag with its predefined size and calculating the distance between the camera center and the mirror tag on the basis of the comparison of the detected size of the predefined object and its predefined size.

Hereby, the distance between the camera center and the mirror tag can be determined in an easy and reliable manner. It may be an advantage that the size of the predefined object of the mirror tag is easy to detect. Accordingly. In one embodiment, the predefined object of the mirror tag is circular. It may be an advantage that the predefined object of the mirror tag is surrounded by an area having a color that provides a large contrast to the color of the predefined object of the mirror tag.

In one embodiment, the color of the predefined object of the mirror tag is blue, green or white, wherein the color of the areas surrounding the object of the mirror tag is black.

By the term “size of the predefined objects is known” is meant that the physical area of the predefined objects seen from the camera is known. The size may be defined as pixels in the image sensor of the camera.

In one embodiment, the reflective zone is surrounded by a circular frame having the same outside size (diameter) as the camera tag. Accordingly, the camera will see a circular “selfie” image with the same pixel diameter when there is a predefined optical distance between the reflective zone of the mirror tag and camera center.

By moving the camera along the optical axis of the lens of the camera, two positions can be found where the pixel size of a circular camera tag matches the pixel size of a circular mirror tag. The distance between these two positions is the same as the distance from the reflective zone of the mirror tag to the position for the image of the camera tag.

By using this procedure to find the distance between the camera and the mirror tag, the radial distortion in the lens can be eliminated since both images are generated in the same manner. The optical distance from the camera center to the camera tag will be the same as the optical distance from the camera center to the mirror frame.

This technique will also make it possible to form both images at a distance where the lens will have the object in focus.

With a focused object the size of the object can be found with high precision in the images.

The camera tag and the mirror tag do not have to be of the same physical size, but their sizes must be known. By using the robot (e.g. a robot arm) to find the positions, from which they form an image of the same pixel size, these positions can be used to calculate to the distance from the camera center to the mirror.

In one embodiment, the mirror tag comprises a rotation marker (also referred to as a rotation tag) arranged in a distance from the reflective zone of the mirror tag, wherein the distance between the camera center and the mirror tag is determined by a triangulation process comprising the following steps:
while maintaining the camera center in a predefined position above the mirror tag displacing the camera a non-zero distance along the plane of the mirror tag and rotating the camera into a position and orientation, in which the camera center axis is pointed towards a rotation marker at the edge of the mirror tag,
determining the angle between the plane of the mirror tag and the camera center axis and the non-zero distance,
calculating the distance on the basis of the angle and the non-zero distance.

As illustrated in FIG. 2C, calculation of the distance D on the basis of the angle α₁ and the non-zero distance L can be done by using the following formula:

$$D = L cos ( {α}_{1} ) . \qquad ( 1 )$$

In a preferred, the camera is attached to an articulated robot arm.

When the robot arm holds the camera in a known position, above the mirror tag, the robot can rotate the camera to point the camera center axis towards a rotation marker of the mirror tag. By keeping the camera center at the known position and aiming the camera center axis (also referred to as the camera lens center axis) at the center of this (preferably round) rotation marker, a new orientation for the camera can be found. The angular difference between this new orientation and the orientation for the center of the rotation marker of the mirror tag can, together with information on the size of the rotation marker of the mirror tag, can be used to calculate the distance from the camera center to the mirror. This is illustrated in FIG. 2C and the above-mentioned formular (D=L cos(α₁)) can be applied.

In one embodiment, the rotation marker is arranged closer to the edge of the mirror tag than the reflective zone.

In one embodiment, the distance between the camera center and the mirror tag is determined by:
applying a mirror tag comprising an elliptic object (an ellipse) shaped as a plane cut through a cone at a predefined angle, wherein the major axis of the elliptic object is defined by the orientation of the cone,
bringing the camera into a (x,y) position and predefined angle, from which the ellipse object is seen as elliptical shape is seen from the same direction as the center line of the original cone, it will form a circular object in the image.

When the camera center is at the right height over the mirror tag the elliptical tag will form a round shape at the center of the image. If the camera center is not at the right height over the mirror tag the elliptical tag will for oval shape offset from the image center.

If the distance between the camera center and the center of the ellipse object is N and the predefined angle is θ, the distance D, between the camera center and the mirror tag projected on the plane of the mirror tag can be calculated by the following formula:

$$D = N / ( {tan}^{- 1} ( θ ) ) \qquad ( 2 )$$

This is shown in and explained with reference to FIG. 3A, FIG. 3B and FIG. 3C.

When the robot arm maintains the camera in a known position, above the mirror tag, the robot can rotate the camera to point the camera center axis towards a rotation marker of the mirror tag. By keeping the camera center at the known position and pointing the camera center axis towards the center of the rotational marker, a new orientation for the camera can be found. In one embodiment, the rotational marker is elliptic. In one embodiment, the rotational marker is circular. The angular difference between this new orientation and the orientation for the center of the mirror tag can, together with information on the size of the mirror tag, can be used to calculate the distance from the camera center to the mirror.

If the camera sees a circular rotation tag at an angle, this shape of this object in the image will not be circular. By giving the rotation tag an oval shape it will form a circular object in the image.

When the camera center axis points towards the center of a circular rotation tag while the camera center axis extends perpendicular to the plane of the mirror tag, the object seen by the camera be a circle around the image center. In this situation the lens distortion will not affect the system. The lens distortion may affect the size of the rotation tag in the image but it will not alter the center position.

In one embodiment, triangulation from a known position in the robot coordinate system can be repeated by using several rotation tags arranged in different locations between the edge of the mirror tag and the reflective zone. Hereby, it is possible to determine the distance between the camera center and the mirror tag with a higher accuracy.

In an embodiment, at least some of the predefined objects of the mirror tag are circular.

In an embodiment, at least some of the predefined objects of the mirror tag are elliptic.

In an embodiment, at least some of the rotation markers of the mirror tag are circular.

In one embodiment, the mirror tag comprises several objects arranged in positions that makes it possible to recognize the orientation of the mirror tag by comparing the image that the several objects constitute with a predefined pattern/image, wherein the method comprises the following steps:
while maintaining the center axis of the camera extending perpendicular to the first plane of the mirror tag, bringing the camera into a position, in which the distance between the camera center and the mirror tag have a predefined level and the center axis of the camera pass through the center of the reflective area on the mirror tag;
rotating the camera about the center axis of the camera until the objects are arranged in such positions that the objects constitute the predefined pattern/image;
detecting how much the camera has been rotated about the center axis of the camera.

Hereby, it is possible to determine the rotational position of the camera in an easy, accurate and reliable manner.

The relative rotation between the camera and the mirror tag can be determined (calibrated) by recognizing details in the mirror tag. In one embodiment, these details include structures of the frame of the reflective zone of the mirror tag. In one embodiment, these details include structures surrounding the frame of the reflective zone of the mirror tag. Said structures may include circular structures and/or square structures and/or triangular structures.

The mirror tag comprises structures having some graphic details that makes it possible to recognize the orientation of the mirror by comparing the image of these details with a known pattern.

In one embodiment, a ring of a specific indicators (e.g. spaced apart circles and/or rectangles and/or triangles) is placed around the frame on the mirror.

In one embodiment, the ring of a specific indicators comprises white dots arranged on a black background.

It may be an advantage that the structures have a high contrast to the background.

In one embodiment, one or more of the indicators can have a special shape or color.

In one embodiment, the method comprises the initial step of letting the camera identify one or more special indicators. Hereby, the general orientation of the mirror tag can be determined.

In one embodiment, the method comprises the additional step of using all the centers of the indicators (e.g. circular and/or rectangular and/or triangular structures) to find the rotation with a high accuracy by fitting the image to the known pattern.

By fitting the known pattern to the image, the rotation between the camera and the mirror tag can be found with higher precision. The robot arm can rotate the camera to give the best fit between the image and the known pattern.

By pointing the camera center axis to the center of the mirror tag the distortion in the lens will not affect the directions from the image center to features at the edge of the image. By rotating the camera to align the directions from the image center to the features with the directions from the center of the mirror tag to the features on the mirror tag the rotation of the camera can be aligned with high precision.

The rotation around the Z axis (see FIG. 1D and FIG. 4C) can also be found by moving the robot (e.g. the robot arm).

When the camera center axis (which corresponds to the lens center axis) is perpendicular to the plane of the mirror tag, the robot can move the camera to a new position while maintaining the camera orientation perpendicular to the mirror. By bringing the camera to a position where the camera center axis is pointed towards the center of a rotation tag, a position for this tag can be found. By comparing the position of the center for the reflective zone of the mirror tag to the center for the rotation tag, a direction or rotation for the mirror tag can be calculated.

By analyzing the images, the rotational position of the camera with respect to the mirror tag can be optimized for the camera to fit to the mirror tag.

Now all six degrees of freedom for describing the relation between the camera and the mirror tag have been determined and the relative position of the robot (e.g. robot arm) to the workplace is known.

In one embodiment, the method according to the invention comprises the step of illuminating the mirror tag with spots that crosses the camera center line in order to prevent blinding the camera.

In one embodiment, the method comprises the step of using the capability of a robot arm to move the camera between different positions without changing the orientation of the camera.

The method and system according to the invention applies a camera that preferably is provided with a camera tag (preferably a ring-shaped tag surrounding the central portion of the camera lens. By using a mirror tag provided on a counterpart (e.g. the workplace), the accuracy of the alignment can be much higher than with the classic systems. Especially the angular alignment can be very accurate when using this concept. It is even possible to match the angular repeatability of the robot.

With this increased accuracy with respect to the angular alignment, the robot can obtain a high precision for positions on a wider working area. The method and system according to the invention makes it possible for a mobile robot to align to a workplace and perform operations with a precision close to what is possible in a stationary installation.

In one embodiment, the camera is configured to emit colored light (e.g. red light) to avoid noise from outside or mistake elements in the surroundings as the camera tag.

In one embodiment, the camera is moved automatically by using an actuator that is controlled by a control unit that receives feedback from the camera.

The mirror tag according to the invention is a mirror tag for calibrating the position and orientation of a robot with respect to a predefined plane and point of reference of a workplace, wherein the mirror tag comprises a reflective zone wherein the reflective zone of the mirror tag has a planar surface extending along a first plane, wherein the mirror tag comprises a plurality of predefined object each having a predefined size, color, geometry and position on the mirror tag, wherein the predefined object are arranged between the reflective zone and an edge of the mirror tag.

Hereby, it is possible to carry out the method by using the mirror tag.

In one embodiment, the mirror tag is rectangular.

In one embodiment, the mirror tag is square. In one embodiment, the mirror tag is round.

In one embodiment, the mirror tag comprises one or more circular rotation markers.

In one embodiment, the mirror tag comprises one or more rectangular rotation markers.

In one embodiment, the mirror tag comprises one or more square rotation markers.

In one embodiment, the mirror tag comprises one or more triangular rotation markers.

The rotation markers may be arranged between the reflective zone and an edge of the mirror tag.

In one embodiment, the rotation markers are evenly distributed around the reflective zone of the mirror tag.

In one embodiment, the rotation markers are arranged in the same distance from the center of the reflective zone of the mirror tag.

In one embodiment, the mirror tag comprises a ring-shaped frame surrounding the reflective zone.

In one embodiment, the rotation markers are arranged in the same distance from the center of the ring-shaped frame.

In one embodiment, the mirror tag comprises a ring of structures surrounding the ring-shaped frame surrounding the reflective zone.

In one embodiment, the ring on the reflective zone is concentrically arranged relative to the reflective zone.

In one embodiment, the mirror tag comprises one or more elliptic markers arranged in a non-zero distance from the reflective zone.

The calibration system according to the invention is a calibration system for calibrating the position and orientation of a robot with respect to a predefined plane and point of reference of a workplace, wherein the calibration system comprises a camera and a mirror tag according to the invention.

In one embodiment, the camera comprises a circular camera tag.

In one embodiment, the camera comprises a spherical camera tag.

In one embodiment, the camera tag is configured to emit coloured light.

### BRIEF DESCRIPTION OF THE DRAWINGS

The invention will become more fully understood from the detailed description given herein below. The accompanying drawings are given by way of illustration only, and thus, they are not limitative of the present invention. In the accompanying drawings:

FIG. 1A shows a calibration system according to the invention used to carry out a method according to the invention;

FIG. 1B shows the calibration system shown in FIG. 1A in another configuration;

FIG. 1C shows a top view of a mirror tag of a system according to the invention;

FIG. 1D shows a perspective view of the mirror tag shown in FIG. 1C;

FIG. 2A shows a side view of camera arranged in a first position above a mirror tag according to the invention;

FIG. 2B shows a side view the camera shown in FIG. 2A arranged in a second position above a mirror tag;

FIG. 2C shows a side view of two configurations of a calibration system according to the invention used to carry out a method according to the invention;

FIG. 2D shows a perspective view of a calibration system according to the invention used to carry out a method according to the invention;

FIG. 3A shows a calibration system according to the invention used to carry out a method according to the invention;

FIG. 3B shows the calibration system shown in FIG. 3A in another configuration;

FIG. 3C shows a triangle related to three distances used when carrying out the calibration process according to the invention;

FIG. 4A shows a calibration system according to the invention used to carry out a method according to the invention;

FIG. 4B shows another view of the calibration system shown in FIG. 4A;

FIG. 4C shows a camera of a calibration system according to the invention mounted in an articulated robot arm;

FIG. 5A shows a cone according to the invention;

FIG. 5B shows an elliptic tag with a shape similar to the cone cut shown in FIG. 5A;

### DETAILED DESCRIPTION OF THE INVENTION

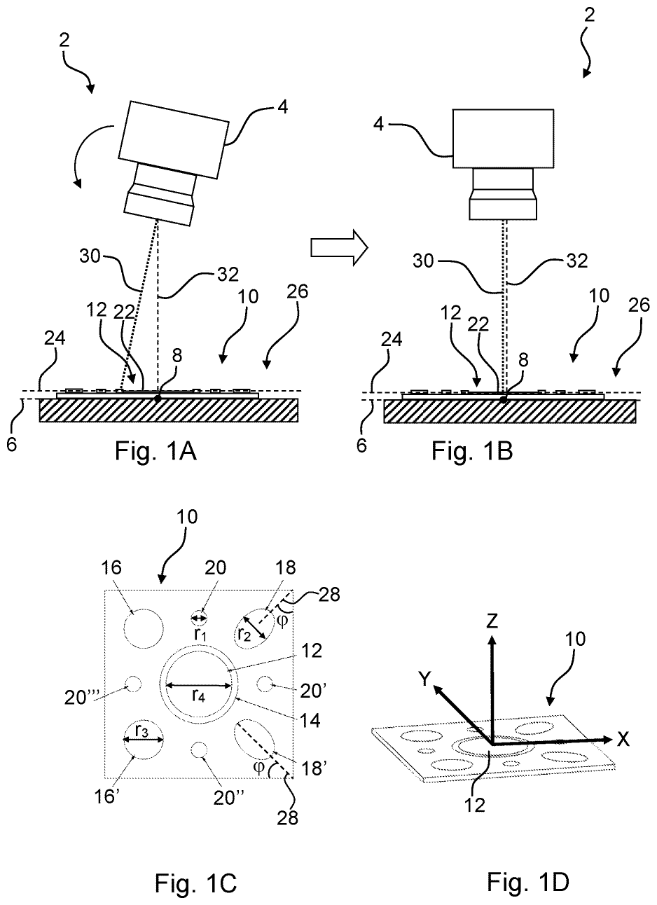

Referring now in detail to the drawings for the purpose of illustrating preferred embodiments of the present invention, a calibration system 40 of the present invention is illustrated in FIG. 1.

FIG. 1A illustrates a calibration system 2 according to the invention used to carry out a method according to the invention. The method is a method for calibrating the position and orientation of a robot (not shown) with respect to a predefined plane 6 and point of reference 8 of a workplace 26.

The calibration system 2 comprises a camera 4 that is attached to a robot (not shown). The camera 4 has a camera center 34 and the camera 4 is configured to emit light along its center axis 30. The robot may be an articulated robot arm.

The calibration system 2 comprises a mirror tag 10 that comprises a reflective zone 12 that is configured to reflect light emitted by the camera 4. The reflective zone 12 of the mirror tag 10 has a planar surface 22 extending along a first plane 24. The mirror tag 10 comprises a normal axis 32 that extends perpendicular to the first plane 24. The predefined plane 6 extends parallel to the first plane 24 and the point of reference 8 lies within the predefined plane 6. The reflective zone 12 may be designed as a planar mirror.

In FIG. 1A the center axis 30 is not parallel with the normal axis 32 of the mirror tag 10. Accordingly, the camera 4 needs to be moved in order to bring the camera 4 into a position an orientation, in which the first plane 24 of the mirror tag 10 is perpendicular to the center axis 30 of the camera 4.

The method of the invention comprises the step of bringing the camera 4 into a position and orientation, in which the first plane 24 of the mirror tag 10 is perpendicular to the center axis 30 of the camera 4. This can be done by moving the camera 4 until the first plane 24 of the mirror tag 10 extends perpendicular to the center axis 30 of the camera 4. Moving can include displacement and/or rotation of the camera 4. In one embodiment, the camera 4 comprises lens and a ring-shaped camera tag surrounding the lens. Hereby, the light emitted by the camera 4 will constitute a right cone (a solid that has a circular base and a single vertex, wherein the vertex is arranged over the center of the base).

FIG. 1B illustrates the calibration system shown in FIG. 1A in a configuration, in which the camera shown in FIG. 1A has been rotated anticlockwise. Hereby, the camera 4 has been brought into a position and orientation, in which the first plane 24 of the mirror tag 10 is perpendicular to the center axis 30 of the camera 4.

In one embodiment, the method comprises the step of bringing the camera 4 into a position and orientation, in which the camera 4 will be able to see itself in the reflective zone 12 on mirror tag 10. This step can be carried out shown in and explained with reference to FIG. 1A and FIG. 1B.

Before starting the alignment procedure shown in and explained with reference to FIG. 1A and FIG. 1B, the robot (not shown) must bring the camera 4 to a position where the camera 4 will be able to see itself in the reflective zone 12 of the mirror tag 10.

If the robot has a rough idea on the position of the workplace 26 no support will be necessary for this first positioning. The initial positioning of the camera 4 can also be done with the help of fiducial markers, AprilTags or similar graphical object that can be recognized by a vision camera and used to guide the robot into a start position, in which the camera 4 will see itself in the reflective zone 12 of the mirror tag 10.

As a help to recognize itself, the camera 4 may comprise a camera tag that is illuminated in different colors. By making a series of images, in which the camera tag is illuminated in different colors and analyzed for this shift in colors, it will be possible to find the camera tag. The color shift can also help verifying that the located structure is actually the camera tag and not just another circular object.

FIG. 1C illustrates a top view of a mirror tag 10 of a system according to the invention. The mirror tag 10 corresponds to the one shown in FIG. 1A and FIG. 1B. The mirror tag 10 comprises a centrally arranged circular reflective zone 12. The reflective zone 12 is surrounded by a predefined object 14 formed as a ring. The radius r₄ of the reflective zone 12 is indicated.

A plurality of objects 16, 16′, 18, 18′, 20, 20′, 20″, 20″ are placed on the mirror tag 10.

The mirror tag 10 comprises two circular markers 16, 16′ arranged in a non-zero distance from the reflective zone 12. The circular markers 16, 16′ are arranged in the same distance from the center of the reflective zone 12. The circular markers 16, 16′ have the same size. The radius r₃ of the circular markers 16, 16′ is indicated. It can be seen that the radius r₃ of the circular markers 16, 16′ is smaller than radius r₄ of the reflective zone 12. Each circular marker 16, 16′ is arranged close to a corner of the mirror tag 10. In FIG. 1C a circular marker 16, 16′ is arranged close to the upper left and lower left corner of the mirror tag 10.

The mirror tag 10 comprises two elliptic markers 18, 18′ arranged in a non-zero distance from the reflective zone 12. The elliptic markers 18, 18′ are arranged in the same distance from the center of the reflective zone 12. The elliptic markers 18, 18′ have the same size but are oriented differently. Each of the elliptic markers 18, 18′ has a major axis 28 that extends parallel to the diagonal extending between the center and the closest corner of the mirror tag 10. Since the mirror tag 10 is square, the angle φ major axis 28 and the edge of the mirror tag 10 is 45 degrees. The length of minor axis r₂ of the elliptic markers 18, 18′ is indicated. It can be seen that the length of minor axis r₂ of the elliptic markers 18, 18′ is smaller than radius r₄ of the reflective zone 12. Each elliptic markers 18, 18′ is arranged close to a corner of the mirror tag 10. In FIG. 1C an elliptic marker 18, 18′ is arranged close to the upper right and lower right corner of the mirror tag 10.

The mirror tag 10 comprises four rotation markers 20, 20′, 20″, 20′″ arranged in a non-zero distance from the reflective zone 12 of the mirror tag 10. In a preferred embodiment, the four rotation markers 20, 20′, 20″, 20″ have the same size and are evenly distributed along the periphery of the mirror tag 10. The four rotation markers 20, 20′, 20″, 20″ are arranged in the same distance from the center of the reflective zone 12. The rotation markers 20, 20′, 20″, 20′″ are circular. The radius r₁ of the rotation markers 20, 20′, 20″, 20′″ is indicated.

The first rotation marker 20 is arranged between a first circular marker 16 and a first elliptic marker 18.

The second rotation marker 20 is arranged between the first elliptic marker 18 and a second elliptic marker 18′.

The third rotation marker 20″ is arranged between the second elliptic marker 18′ and a second circular marker 16′.

The fourth rotation marker 20″ is arranged between the second circular marker 16′ and the first circular marker 16.

In one embodiment, the color of the ring 14 provides contrast to the reflective zone 12. In one embodiment, the color of the ring 14 is blue.

The mirror tag 10 is square. In another embodiment, however, the mirror tag 10 may be rectangular, circular, oval, hexagonal or octagonal.

FIG. 1D illustrates a perspective view of the mirror tag shown in FIG. 1C. A Cartesian coordinate system having a first lateral axis X, a second lateral axis Y and a normal axis Z is indicated. Origin is placed in the center of the reflective zone 12.

Aligning the camera 4 to the plane 24 of the mirror tag 10 as shown in and explained with reference to FIG. 1A and FIG. 1B is done by rotating the camera 4 around the X axis and the Y axis (shown in FIG. 1D).

By making adjustments to the orientation of the robot (e.g. robot arm), the camera 4 can be brought to a position, in which the camera tag is seen by the camera as a full circle. By using the center of the image of the camera tag as a guide, the robot (e.g. robot arm) can rotate the camera 4 to a position, in which the center of the camera tag is moved to the optical center of the image seen by the camera 4.

When the center of the camera tag is at the optical center in the image seen by the camera 4, the center axis 30 of the camera (corresponding to the optical axis of the lens of the camera 4) extends perpendicular to the plane 24 of the mirror tag 10 and the image sensor plane in the camera 4 extends parallel to the plane 24 of the mirror tag 10. Lens distortion will not affect this alignment of the camera 4 relative to the mirror tag 10 since light passing along the center line of the lens will not be distorted.

When the camera 4 is supposed to extend parallel to the mirror tag 10, the distance between the camera 4 and the reflective zone 12 of the mirror tag 10 can be adjusted to check the quality of the alignment.

The robot (robot arm) can be used to move the camera 4 along the center axis 30 of the camera (this corresponds to the optical axis of the lens of the camera 4). If the distance between the camera 4 and the reflective zone 12 of the mirror tag 10 is increased, even a small angular misalignment will cause the offset of the camera tag center from the optical center in the image seen by the camera 4 will increase as function of the distance. This test with increased distance can give the alignment an extremely high precision. Probably better than 0.3 milliradian, which is similar to the repeatability of the robot arm.

A larger distance has a disadvantage: The size of the camera tag in the image will be smaller. The distance will also be limited by the focus range of the lens of the camera. In the image seen by the camera 4, a small camera tag, out of focus, will be difficult to detect with high precision.

When the image sensor of the camera 4 extends parallel to the plane 24 of the mirror tag 10, the rotation along the X axis and the Y axis of the mirror tag 10 are identified. Accordingly, two rotation angles and thus two of the six degrees of freedom of the camera 4 are now fixed.

When a viewer sees his own eye in a mirror, his line-of-sight into the mirror will not only be perpendicular to the mirror but the position of this line-of-sight on the mirror will also depend on the position of the viewers' eye in relation to the mirror. The distance from the line-of-sight to the frame of the mirror will reflect the relative position between the viewers eye and the frame of the mirror.

The image of the camera tag seen by the camera 4 will also show the ring 14 surrounding the reflective zone 12 of the mirror tag 10. The position of the camera tag center relative to the center of the reflective zone 12 of the mirror tag 10 can be found in the image seen by the camera 4 and used to determinate the relative position of the center axis 30 of the camera 4 in relation to the center of the reflective zone 12 of the mirror tag 10.

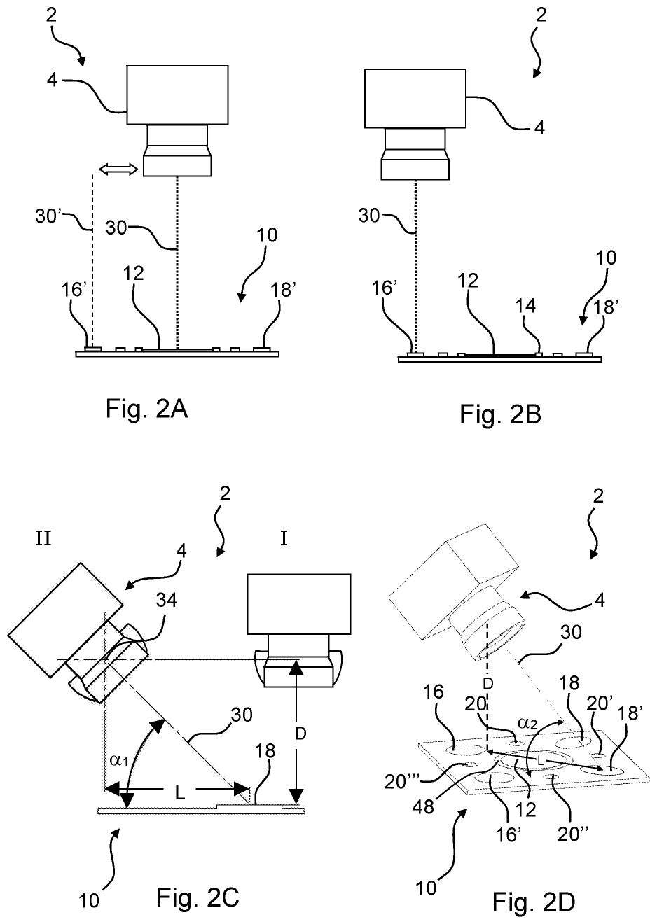

FIG. 2A illustrates a side view of camera 4 arranged in a first position above a mirror tag 10 according to the invention. FIG. 2B illustrates a side view the camera 4 shown in FIG. 2A arranged in a second position above the mirror tag 12. When comparing FIG. 2A and FIG. 2B one can see that the camera 4 is being moved from a first position, in which the camera center axis 30 points towards, intercepts the center of the reflective zone 12 and wherein the camera center axis 30 extends perpendicular to the plane of the mirror tag 12. Accordingly, the camera center axis 30 extends parallel to the normal axis of the mirror tag 10 that extends perpendicular to the plane of the mirror tag 10.

In FIG. 2B, the camera 4 has been displaced along the plane of the mirror tag 10 until the camera center axis 30 points towards and intercepts the center of the circular marker 16. The orientation of the camera center axis 30 is maintained. Accordingly, the camera center axis 30 extends perpendicular to the plane of the mirror tag 12. It can be seen that the mirror tag 10 comprises additional markers 18′ and a ring 14. The mirror tag 10 may be similar to the one shown in FIG. 1A, FIG. 1B, FIG. 1C and FIG. 1D. The mirror tag 10 may, however, differ from the one shown in FIG. 1A, FIG. 1B, FIG. 1C and FIG. 1D.

In the following alignment of the positions of the camera 4 and mirror tag 10 is described. The camera 4 is moved into a position in which the center axis 30 of the camera 4 points towards and intersects the center of the reflective zone 12 of the mirror tag 10. This alignment can be carried out by moving the center axis 30 of the camera 4 and thus the optical axis of the lens of the camera 4 by adjusting the X and Y position of the robot (robot arm). When the image of the center of the reflective zone 12 and the ring 14 (the mirror frame) is at the optical center of the image seen by the camera, the positions of the camera 4 and mirror tag 10 are aligned on a plane extending parallel to the plane 24 of the mirror tag 10 and the image sensor in the camera 4.

When the center of the ring 14 of the mirror tag 10 are aligned to the center axis 30 of the camera 4, the position of the X axis and the Y axis on the plane 24 of the mirror tag 10 are identified. Accordingly, four of the six degrees of freedom of the camera 4 are determined.

The mirror tag 10 comprises a plurality of predefined object 16′, 18′ each having a predefined size, geometry and position on the mirror tag 10. Accordingly, by
maintaining the orientation of the camera 4 relative to the plane of the mirror tag 10 and;
displacing the camera 4 along said plane of the mirror tag 10 until the center axis 30 of the camera 4 is pointed towards one of the predefined points of one of the predefined objects 16′, 18′ of the mirror tag 10,
it is possible to determine the position of the X axis and the Y axis on the plane 24 of the mirror tag 10.

FIG. 2C illustrates a side view of two configurations of a calibration system according to the invention used to carry out a method according to the invention. Initially (in the first configuration I), the camera 4 is arranged in a position above the mirror tag 10, in which the center axis 30 of the camera 4 is pointed towards a predefined point of a predefined object 18′ of the mirror tag 10. The distance D between the camera center 34 and the predefined object 18′ is indicated in FIG. 2C. It should be noted that the camera center 34 lies within the structure of the camera 4 and it is not visible from outside. Accordingly, the reference 34 indicates the line, along which the camera center is positioned, wherein said line extends parallel to the plane of the mirror tag 10 and perpendicular to the center axis 30 of the camera 4.

In the first configuration I, the center axis 30 of the camera 4 extends perpendicular to the plane of the mirror tag 10. Accordingly, the center axis 30 of the camera 4 extends parallel to the normal axis of the mirror tag 10.

By maintaining the camera center 34 in a fixed distance from the mirror tag 10 and rotating the camera 4, the camera 4 is moved into a second configuration II, in which the center axis 30 of the camera 4 point towards the center of the predefined object 18′. In the second configuration II, the displacement L of the camera center 34 along the plane of the mirror tag 10 is indicated. By detecting the angular displacement α₁ of the camera 4, it is possible to calculate the distance D by the following formula:

$$D = L cos ( {α}_{1} ) \qquad ( 1 )$$

FIG. 2D illustrates a perspective view of a calibration system 2 according to the invention used to carry out a method according to the invention. It is possible to calculate the distance D between the camera center and the predefined object 18′ of the mirror tag 10 in another way that the one explained with reference to FIG. 2C.

The mirror tag 10 comprises an elliptic marker 18′ placed near the lower right corner of the mirror tag 10. The center axis of the camera 4 point towards a predefined point the elliptic marker 18′.

The elliptic marker 18′ has a major axis extending 45 degrees relative to the edges of the adjacent sides defining the corner at which the elliptic marker 18′ is placed. By maintaining the camera center in a fixed distance from the mirror tag 10 and rotating and displacing (along the plane of the mirror tag 10) the camera 4, the camera 4 is moved into a configuration, in which the center axis 30 of the camera 4 point towards a predefined point on the elliptic marker 18′, wherein the center axis 30 of the camera 4 extends along a plane perpendicular to the plane of the mirror tag 10 that extends along the major axis of the elliptic marker 18′ and wherein the camera 4 sees the elliptic marker 18′ as a circle. In this configuration, the angular displacement α₂ of the camera 4, it is possible to calculate the distance D by the following formula:

$$D = L cos ( {α}_{2} ) \qquad ( 1 )$$

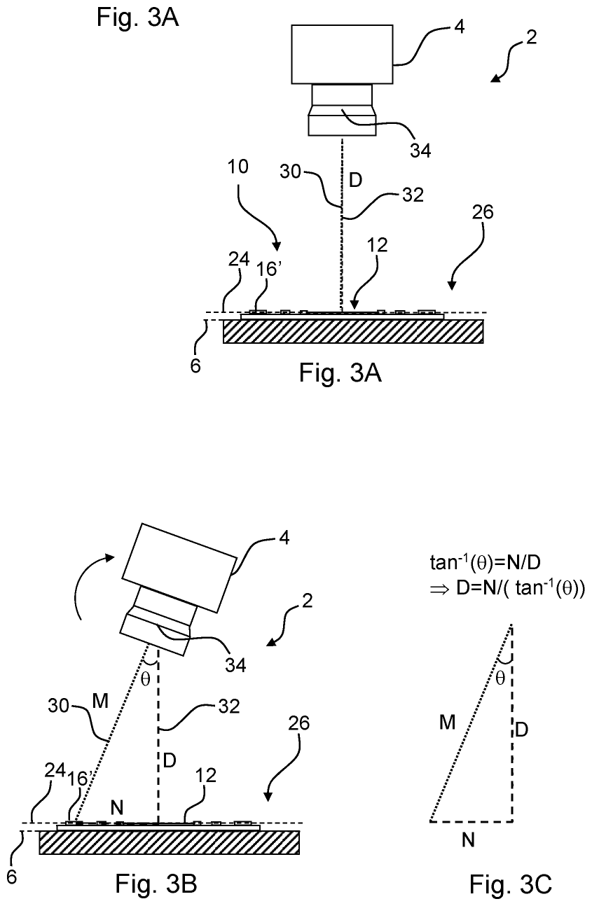

FIG. 3A illustrates a calibration system 2 according to the invention configured to carry out a method according to the invention. The method is a method for calibrating the position and orientation of a robot (not shown) with respect to a predefined plane 6 and point of reference of a workplace 26.

The calibration system 2 comprises a mirror tag 10 corresponding to one of the ones shown in or explained with reference to FIG. 1A, FIG. 1B, FIG. 1C, FIG. 1D, FIG. 2A, FIG. 2B, FIG. 2C or FIG. 2D. The calibration system 2 comprises a camera 4 having a camera center 34 arranged in a non-zero distance D above the mirror tag 10. It should be noted that the camera center 34 lies within the inside structures of the camera 4 and thus the camera center 34 cannot be seen from the outside as explained with reference to FIG. 2C.

In FIG. 3A, the center axis 30 of the camera 4 extends parallel to the normal axis 32 of the mirror tag 10. The normal axis 32 of the mirror tag 10 extends perpendicular to the first plane 24 of the mirror tag 10. The predefined plane 6 extends parallel to the first plane 24. Moreover, the center axis 30 of the camera 4 points towards the center of the ring 14 around the reflective zone of the mirror tag 10.

FIG. 3B shows the calibration system 2 shown in FIG. 3A in another configuration, in which the camera center 34 is maintained in the same position relative to the mirror tag 10 as in FIG. 3A while the camera 4 is rotated clockwise until the center axis 30 of the camera 4 points towards the center of a predefined object 16′ arranged in a predefined distance N from the center of the reflective zone 12 of the mirror tag 10. The angular displacement θ is indicated. The distance M between the camera center 34 is indicated.

FIG. 3C shows a triangle related to three distances M, D, N used when carrying out the calibration process according to the invention. Since the angle θ and the distance N are known, it is possible to calculate the distance D by using the following formula:

$$D = N / ( {tan}^{- 1} ( θ ) ) \qquad ( 2 )$$

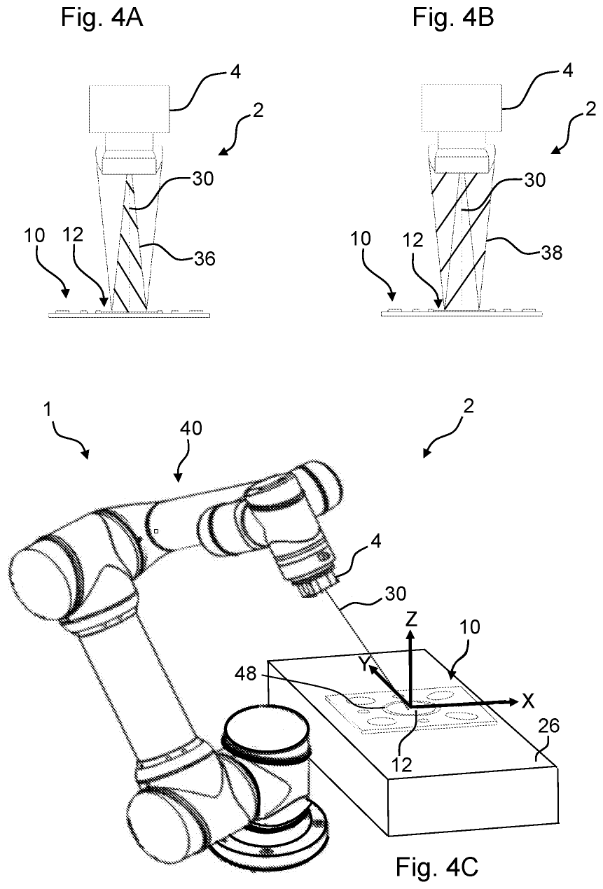

FIG. 4A shows a calibration system 2 according to the invention used to carry out a method according to the invention. The calibration system 2 comprises a camera 4 collecting light 38 & 36 emitted from the Camera Tag. The collected light 36 constitutes a cone. The collected light 36 is transmitted via the reflective zone 12 of a mirror tag 10 arranged below the camera 4.

FIG. 4B shows another view of the calibration system 2 shown in FIG. 4A. It can be seen that the reflective zone 12 reflect the light 38 and thus transmits reflected light 36 towards the lens (not shown) of the camera 4. Accordingly, when the camera 4 is arranged as shown in FIG. 4A and in FIG. 4B, the camera 4 is capable of seeing an image of itself.

FIG. 4C illustrates a camera of a calibration system 2 according to the invention comprising a camera 4 that is mounted on an articulated robot arm 40. The calibration system 2 comprises a mirror tag 10 corresponding to the one shown in and explained with reference to FIG. 1C, FIG. 1D. and FIG. 2D. It can be seen that a Cartesian coordinate system having a first lateral axis X, a second lateral axis Y and a normal axis Z is indicated. Origin is placed at the center of the ring 14 around reflective zone 12 The calibration system 2 is suitable and configured for calibrating the position and orientation of the robot with respect to the plane and point of reference of the workplace 26.

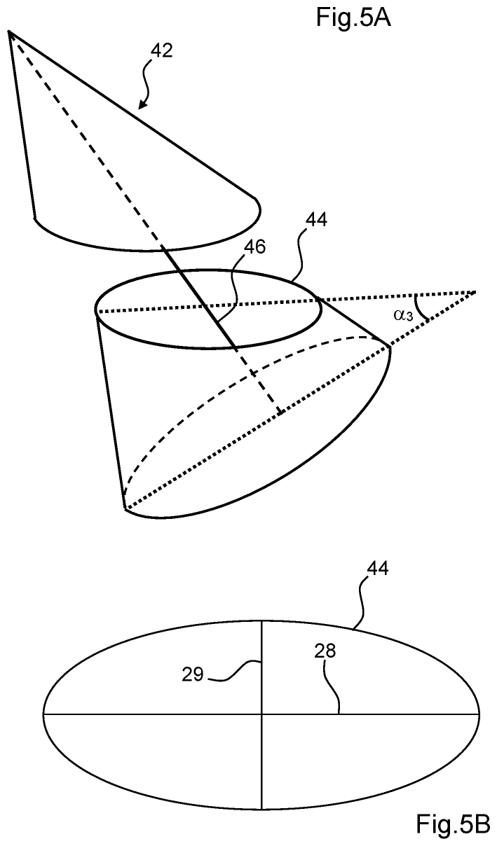

FIG. 5A illustrates a cone 42 representing the light collected by a camera of a calibration system according to the invention. The cone 42 has a cone axis 46 that is indicated. A cut 44 angled with an angle 3 relative to the base of the cone 42 is made in the cone 42. The cut 44 constitutes an ellipse. The angle α₃ between the plane of the ellipse and the base of the cone 42 is indicated.

The distance between camera and the mirror tag can be determined by a different technique. When the robot arm holds the camera in a known position, above the mirror tag, the robot can rotate the camera to point the center axis of the camera towards the central area of a circular rotation marker of the mirror tag. By maintaining the camera center at the known position and pointing the center axis of the camera towards the center of a circular rotation marker, a new orientation for the camera can be found. The angular difference between the new orientation and the orientation for the center of the mirror tag can, together with information on the size of the mirror tag, can be used to calculate the distance between the camera center to the mirror tag.

If the camera sees a round tag at an angle, the shape of the object in the image will not be circular. By giving the rotation tag an oval shape it will form a circular object in the image.

When the center axis of the camera points towards the center of the rotation tag, the object in the image will be a circle around the image center. In this situation the lens distortion will not affect the system. The lens distortion may affect the size of the rotation tag in the image, but it will not alter the center position.

This triangulation from a known position in the robot coordinate system can be repeated with more rotation tags around the mirror tag to give a higher precision of the rotation of the mirror tag. With well-defined positions of the rotation tags (16) and the center of the mirror tag, the rotation of the Z axis is now known. Accordingly, five of the six degrees of freedom are determined.

FIG. 5B illustrates the ellipse provided by the cut 44 shown in and explained with reference to FIG. 5A. The ellipse comprises a major axis 28 and a minor axis 29.

In one embodiment, the mirror tag is located on a robot, and the camera is mounted on a workstation.

### LIST OF REFERENCE NUMERALS

1 Robot
2 Robot calibration system
4 Camera
6 Predefined plane
8 Point of reference
10 Mirror tag
12 Reflective zone
14, 16, 16′ Predefined object
18, 18′ Predefined object
20, 20′, 20″, 20′″ Predefined object
22 Surface
24 First plane
26 Work space
28 Major axis
29 Minor axis
30 Camera center axis
32 Normal axis of the mirror tag
34 Camera center
36 Reflected light
38 Emitted light
40 Articulated robot arm
42 Cone
44 Cut
46 Cone axis
48 Camera tag
I First configuration
II Second configuration
L Known distance
D Distance
α₁, α₂, α₃, β Angle
θ, φ Angle
r₁, r₂, r₃, r₄ Radius/distance
X, Y, Z Axis

1. A method for calibrating a position and orientation of a robot with respect to a predefined plane and point of reference of a workplace, wherein the method comprises the step of providing the robot with a camera having a camera center, wherein the method comprises the following steps:
positioning the camera in a first position, in which the camera faces a mirror tag comprising a reflective zone, wherein the reflective zone of the mirror tag has a planar surface extending along a first plane;
moving the camera until the first plane of the mirror tag is perpendicular to a center axis of the camera, and
bringing the camera into a position, in which the camera is able to see itself in the reflective zone on the mirror tag.

2. The method according to claim 1, wherein the mirror tag comprises a plurality of predefined objects each having a predefined size, color, geometry and position on the mirror tag, wherein the method comprises the following steps:
maintain the orientation of the camera relative to the first plane;
displacing the camera along the first plane until the center axis of the camera is pointed towards one of the predefined points of one of the predefined objects of the mirror tag.

3. The method according claim 1, wherein the method comprises the step of determining the distance between the camera center and the mirror tag.

4. The method according to claim 3, wherein the distance between the camera center and the mirror tag is determined by:
detecting the size of one of the predefined objects of the mirror tag, wherein the size of the predefined objects, is known;
comparing the detected size of the predefined object of the mirror tag with its predefined size and calculating the distance between the camera center and the mirror tag on the basis of the comparison of the detected size of the predefined object and its predefined size.

5. The method according to claim 3, wherein the mirror tag comprises a rotation marker arranged in a distance from the reflective zone of the mirror tag, wherein the distance between the camera center and the mirror tag is determined by a triangulation process comprising the following steps:
while maintaining the camera center in a predefined position above the mirror tag displacing the camera a non-zero distance along the plane of the mirror tag and rotating the camera into a position and orientation, in which the camera center axis is pointed towards a rotation marker at the edge of the mirror tag,
determining the angle between the plane of the mirror tag and the camera center axis and the non-zero distance,
calculating the distance on the basis of the angle and the non-zero distance.

6. The method according to claim 3, wherein the distance between the camera center and the mirror tag is determined by:
applying a mirror tag comprising an elliptic object shaped as a plane cut through a cone at a predefined angle, wherein the major axis of the elliptic object is defined by the orientation of the cone,
bringing the camera into a position and angle, from which the ellipse object when seen from the same direction as the centre line of the original cone, will form a circular object in the image.

7. The method according to claim 1, wherein the mirror tag comprises several objects arranged in positions that makes it possible to recognize the orientation of the mirror tag by comparing the image that the several objects constitute with a predefined pattern/image, wherein the method comprises the following steps:
while maintaining the center axis of the camera extending perpendicular to the first plane of the mirror tag, bringing the camera into a position, in which the distance between the camera center and the mirror tag has a predefined level;
rotating the camera about the center axis of the camera until the objects are arranged in such positions that the objects constitute the predefined pattern/image;
detecting how much the camera has been rotated about the center axis of the camera.

8. The method according to claim 1, wherein the mirror tag comprises a reflective zone configured to reflect light emitted by the camera, wherein the reflective zone of the mirror tag has a planar surface extending along a first plane, wherein the mirror tag comprises a plurality of predefined objects each having a predefined size, geometry and position on the mirror tag, wherein the predefined objects are arranged between the reflective zone and an edge of the mirror tag.

9. The method according to claim 8, wherein the mirror tag comprises one or more circular rotation markers.

10. The method according to claim 8, wherein the mirror tag comprises a ring-shaped frame surrounding the reflective zone.

11. The method according to claim 10, wherein the mirror tag comprises a ring of structures surrounding the shaped frame surrounding the ring-shaped frame.

12. The method according to claim 8, wherein the mirror tag comprises one or more elliptic markers arranged in a non-zero distance from the reflective zone, wherein each of the elliptic markers has a major axis with a predefined angle relative to the mirror tag and a predefined center relative to the mirror tag.

13. A calibration system for calibrating a position and orientation of a robot with respect to a predefined plane and point of reference of a workplace, the calibration system comprising:
a camera being attached to the robot and comprising a camera center, and
a mirror tag comprising a reflective zone having a planar surface extending along a first plane,
wherein the robot is configured to:
position the camera in a first position, which the camera faces the mirror tag,
move the camera until the first plane of the mirror tag is perpendicular to a center axis of the camera, and
bring the camera into a position in which the camera is able to see itself in the reflective zone on the mirror tag.

14. The calibration system according to claim 13, wherein the camera comprises a circular camera tag.

15. The calibration system according to claim 13, wherein the camera tag on the camera is configured to emit coloured colored light.

16. A mirror tag for carrying out the method according to claim 1, wherein the mirror tag comprises a reflective zone configured to reflect light emitted by the camera, wherein the reflective zone of the mirror tag has a planar surface extending along a first plane, and wherein the mirror tag further comprises a plurality of predefined objects, each having a predefined size, geometry and position on the mirror tag, and wherein the predefined objects are arranged between the reflective zone and an edge of the mirror tag.

17. The mirror tag according to claim 16, wherein the mirror tag further comprises at least one circular rotation marker.

18. A mirror tag according to claim 17, wherein the mirror tag further comprises a ring-shaped frame surrounding the reflective zone.

19. A mirror tag according to claim 18, wherein the mirror tag further comprises a ring of structures surrounding the shaped frame surrounding the ring-shaped frame.

20. A mirror tag according to claim, wherein the mirror tag further comprises at least one elliptic marker arranged in a non-zero distance from the reflective zone, wherein each of the at least one elliptic markers has a major axis with a predefined angle relative to the mirror tag and a predefined center relative to the mirror tag.
